(19) United States
(12) Patent Application Publication
(10) Pub. No.: US 2010/0212991 A1
(43) Pub. Date: Aug. 26, 2010

(54) FUEL CELL SYSTEM COMPRISING A REFORMER AND AN AFTERBURNER

(75) Inventors: Matthias Boltze, Wulkenzin (OT Neuendorf ) (DE); Michael Rozumek, Neubrandenburg (DE); Stefan Käding, Zerrenthin (DE); Manfred Pfalzgraf, Herrsching (DE); Andreas Engl, Munich (DE); Beate Bleeker, Munich (DE); Michael Süssl, Munich (DE); Markus Bedenbecker, Gauting (DE)

Correspondence Address: DICKINSON WRIGHT PLLC, 1875 Eye Street, NW, Suite 1200, WASHINGTON, DC, 20006, US

(73) Assignee: ENERDAY GMBH, Stockdorf (DE)

(21) Appl. No.: 12/305,814

(22) PCT Filed: Jun. 21, 2007
(86) PCT No.: PCT/DE2007/001101

§ 371 Date: May 4, 2010

(30) Foreign Application Priority Data
Jul. 13, 2006 (DE) 10 2006 032 471.4

(51) Int. Cl. B60K 15/03; H01M 8/06

(52) U.S. Cl. 180/314; 429/423

(57) ABSTRACT

The invention relates to a fuel cell system (10) which comprises a reformer (12) having an oxidation zone (48) to which stored fuel can be supplied by means of a fuel supply device (50) for reaction with an oxidant; and an afterburner (36) having an oxidation zone (60) to which stored fuel can be supplied by means of a fuel supply device (62) for reaction with an oxidant. The invention is characterized in that the fuel supply device (50) of the reformer (12) and the fuel supply device (62) of the afterburner (36) are adapted to supply fuel in such a manner that the fuel supplied by the fuel supply device (50) of the reformer differs from the fuel supplied by the fuel supply device (62) of the afterburner (36) with respect to the type of fuel and/or its state of aggregation and/or the temperature at which it is supplied. The invention also relates to a motor vehicle comprising said fuel cell system and to a method for operating said fuel cell system.

The invention relates to a fuel cell system comprising a reformer with an oxidation zone receiving a supply of tanked fuel by means of a fuel feeder for reaction with oxidant; and an afterburner with an oxidation zone receiving a supply of tanked fuel by means of a fuel feeder for reaction with the oxidant.

The invention relates in addition to a motor vehicle with such a fuel cell system.

Furthermore, the invention relates to a method of operating a fuel cell system comprising the steps: feeding fuel from a fuel tank to an oxidation zone of a reformer in which the fuel is reacted with the oxidant; and feeding fuel from a fuel tank to an oxidation zone of an afterburner in which the fuel is reacted with the oxidant.

Fuel cell systems serve to convert chemical energy into electrical energy. The central element of such systems is a fuel cell in which electrical energy is liberated by the controlled reaction of hydrogen and oxygen. Fuel cell systems must be capable of processing fuels as usual in practice. Since hydrogen and oxygen are reacted in a fuel cell, the fuel used must be conditioned so that the gas supplied to the anode of the fuel cell has a high percentage of hydrogen—this is the task of the reformer. For this purpose a reformer receives a supply of fuel and oxidant, preferably air, the fuel then being reacted with the oxidant in the reformer. A prior art reformer is known from German patent DE 103 59 205 A1. To, on the one hand, emit combustion exhaust gases of the fuel cell system to the environment with a minimum of toxic emissions and, on the other hand, to provide a source of heat for preheating the various components and media flow feeders of the fuel cell system, an afterburner is provided in the fuel cell system. A prior art afterburner is known from German patent DE 10 2004 049 903 A1.

The object of the present invention is to sophisticate the generic fuel cell systems, the generic motor vehicle and the generic method of operating a fuel cell system such that optimized operation of the fuel cell system is achieved.

This object is achieved by the independent claims.

Advantageous aspects and further embodiments of the invention read from the dependent claims.

The fuel cell system in accordance with the invention is based on generic prior art in that the fuel feeder of the reformer and the fuel feeder of the afterburner are designed to feed fuel such that the fuel supplied by the fuel feeder of the reformer differs from the fuel supplied by the fuel feeder of the afterburner as regards grade and/or state of aggregation and/or feed pressure and/or feed temperature. This has the advantage that as compared to prior art these parameters can now be customized to attain optimum conditions for achieving evaporation in the corresponding oxidation zone of the reformer and afterburner respectively, with the further advantage that the working range of the fuel cell system is broader because the reformer and the afterburner can now be operated improved and adapted to the structural design in each case. This is particularly of advantage when a fuel cell system is to be operated so that an additional thermal output is to be made available in the afterburner e.g. for heating purposes irrespective of the electricity generated. By operating the afterburner with fuel which differs from that of the reformer as regards grade and/or state of aggregation and/or feed pressure and/or feed temperature it is now possible to generate a particularly high thermal output without causing the same effect in the reformer. In this arrangement the reformer could be working with minimum output or even shut off. In stationary operation the combustion in the oxidation zone of the afterburner can be operated so that now the thermal output is maximized without this effecting the other components in the fuel cell system.

The fuel cell system in accordance with the invention can be sophisticated to advantage in that the fuel feeder of the reformer is designed to be connected to a first fuel tank and the fuel feeder of the afterburner is designed to be connected to a separate second fuel tank. Because of the various temperatures, enthalpies and rates of evaporation of the various fuel grades by supplying the oxidation zone of the reformer and the oxidation zone of the afterburner with differing grades of fuel, the fuel grade can now be selected so that the evaporation and the associated reaction in the corresponding zone progresses optimally.

In addition, the invention provides a motor vehicle with such a fuel cell system which furnishes the advantages as described above corresponding.

The generic method may be sophisticated to advantage in that the fuel supplied to the oxidation zone of the reformer differs from the fuel supplied to the oxidation zone of the afterburner as regards grade and/or state of aggregation and/or feed pressure and/or feed temperature. In the scope of the method in accordance with the invention too, this is an advantage over prior art in that these parameters can now be customized to achieve optimum conditions for achieving evaporation in the corresponding oxidation zone of the reformer and afterburner respectively, with the further advantage that the working range of the fuel cell system is broader because the reformer and afterburner can now be operated improved and adapted to the structural design in each case. This is particularly of advantage when a fuel cell system is to be operated so that an additional thermal output is to be made available in the afterburner e.g. for heating purposes irrespective of the electricity generated. By operating the afterburner with fuel which differs from the fuel of the reformer as regards grade and/or state of aggregation and/or feed pressure and/or feed temperature it is now possible to generate a particularly high thermal output without causing the same effect in the reformer. In this arrangement the reformer could be working with minimum output or even shut off. In stationary operation the combustion in the oxidation zone of the afterburner can be operated so that now the thermal output is maximized without this effecting the other components in the fuel cell system.

In addition, the method in accordance with the invention can be sophisticated to advantage in that the fuel supplied to the oxidation zone of the reformer is fed from a first fuel tank and the fuel supplied to the oxidation zone of the afterburner is fed from a second fuel tank. Because of the various temperatures, enthalpies and rates of evaporation of the various fuel grades by supplying the oxidation zone of the reformer and the oxidation zone of the afterburner with differing grades of fuel, the fuel grade can now be selected so that the evaporation and the associated reaction in the corresponding zone progresses optimally.

Preferred embodiments of the invention will now be detailed by way of example with reference to the attached drawings in which:

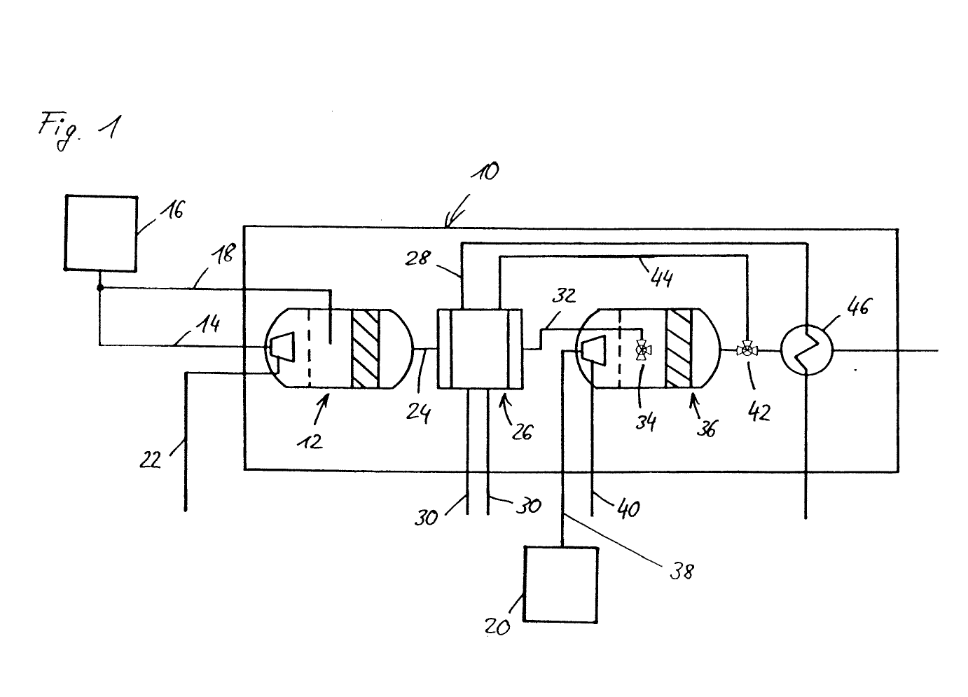

FIG. 1 is a diagrammatic representation of a fuel cell system in accordance with a first example embodiment;

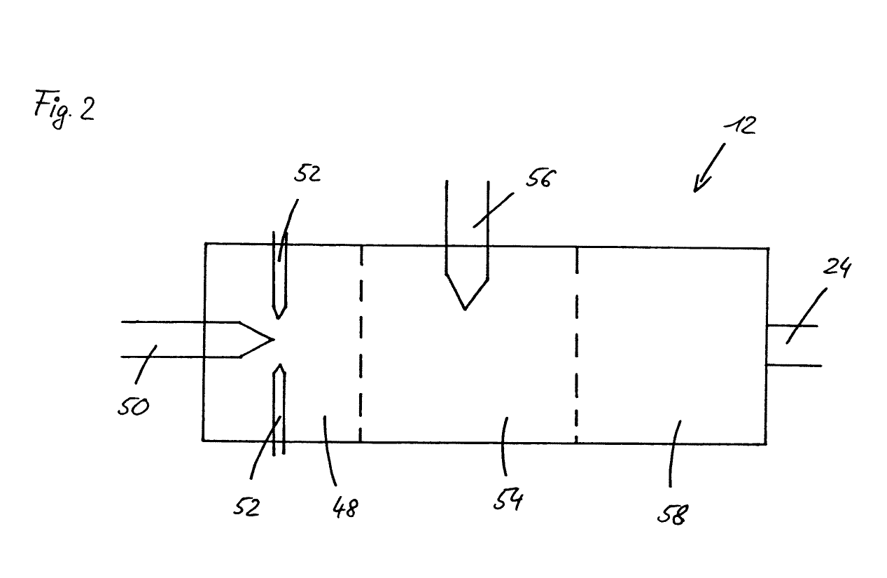

FIG. 2 is a diagrammatic representation of a reformer in accordance with the first example embodiment;

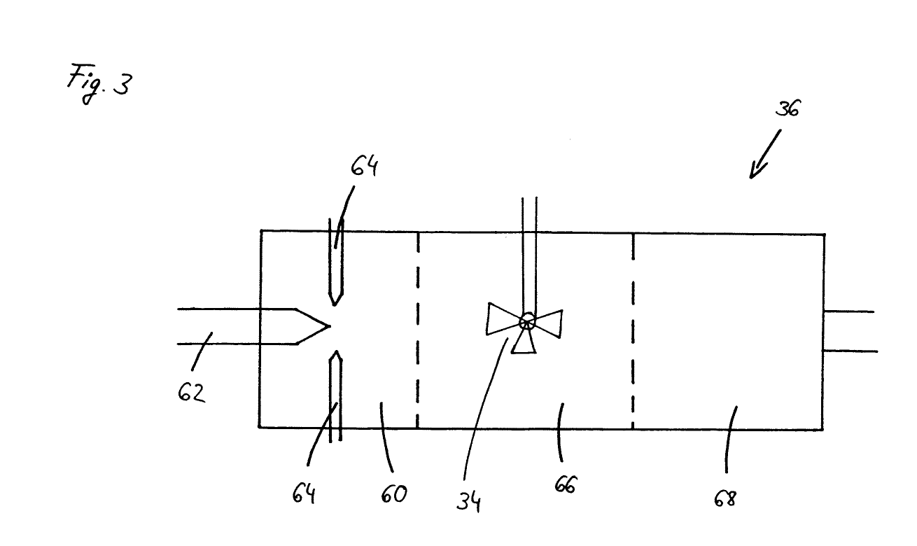

FIG. 3 is a diagrammatic representation of an afterburner in accordance with the first example embodiment;

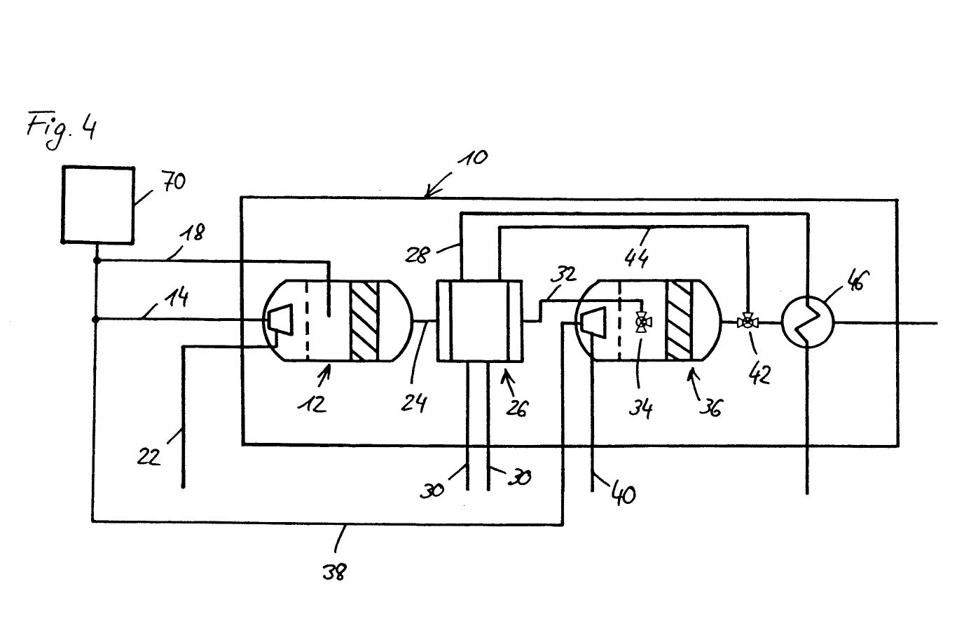

FIG. 4 is a diagrammatic representation of a fuel cell system in accordance with a second example embodiment.

Referring now to FIG. 1 there is illustrated a diagrammatic representation of a fuel cell system in accordance with a first example embodiment. The fuel cell system 10 installed in a motor vehicle comprises a reformer 12 receiving a supply of fuel via a first fuel line 14 from a first fuel tank 16. In addition, the reformer 12 receives a supply of fuel at a further feeder by means of a second fuel line 18 from the first fuel tank 16. Furthermore, the reformer 12 receives a supply of oxidant, for example air, via a first oxidant line 22. The reformate generated by the reformer 12 is supplied via a reformate line 24 to a fuel cell stack 26. The reformate involved is a hydrogen rich gas which is reacted in the fuel cell stack 26 with the aid of cathode feed air furnished via a cathode feed air line 28 in generating electricity and heat. The generated electricity can be picked off via electric terminals 30. In the case as shown, the anode exhaust gas is supplied via an anode exhaust gas line 32 to a mixer 34 of an afterburner 36. The afterburner 36 receives a supply of fuel from a second fuel tank 20 via a third fuel line 38. Suitable grades of fuel for the first and second fuel tank 16, 20 are diesel, gasoline, biogas, natural gas and further grades of fuel known from prior art. In the scope of the first example embodiment the grade of fuel in the first fuel tank 16 differs from that in the second fuel tank 20. Furthermore the afterburner 36 receives a supply of oxidant via a second oxidant line 40. In the afterburner 36 the depleted anode exhaust gas is reacted with the fuel and oxidant feed into a combustion exhaust gas which is mixed in a mixer 42 with cathode exhaust air fed via a cathode exhaust air line 44 from the fuel cell stack 26 to the mixer 42. The combustion exhaust gas containing near zero toxic emissions flows through the heat exchanger 46 to preheat the cathode feed air before finally leaving the fuel cell system 10.

Referring now to FIG. 2 there is illustrated a diagrammatic representation of a reformer in accordance with the first example embodiment. The reformer 12 comprises an oxidation zone 48 comprising a primary fuel feeder 50 by means of which fuel is supplied to the oxidation zone 48. The primary fuel feeder 50 is connected to the first fuel line 14 so that the primary fuel feeder 50 supplies the grade of fuel as tanked in the first fuel tank 16. In addition, the oxidation zone 48 comprises an oxidant feeder 52 connected to the first oxidant line 22 by means of which the oxidation zone 48 can receive a supply of oxidant. Within the oxidation zone 48 a reaction of fuel and oxidant in a combustion or exothermic total oxidation reaction occurs, the resulting hot product gas then entering a downstream mixing zone 54, i.e. to the right in FIG. 2. The individual zones of the reformer are indicated separate from each other in FIG. 2 by broken lines. The zones may be separated from each other by structural features or interface flowingly. In the mixing zone 54 the resulting product gas stream receives an additional supply of fuel by means of a secondary fuel feeder 56. In the present example the primary and secondary fuel feeders 50, 56 each comprise an injector and preferably a Venturi nozzle. It is just as possible, however, that the fuel is supplied by means of an evaporation type fuel feeder comprising a porous evaporator to the oxidation zone 48 and mixing zone 54 respectively. The secondary fuel feeder 56 is connected to the second fuel line 18 so that fuel tanked in the first fuel tank 16 can be supplied to the secondary fuel feeder 56. In addition it may be provided for that the mixing zone 54 receives a supply of oxidant. The gas mixture mixed with the additional fuel enters a reforming zone 58 where it is reacted in an endothermic reaction into a hydrogen rich gas mixture, preferably by means of a catalyst sited therein. This reformate, i.e. hydrogen rich gas mixture leaves the reformer 12 via the reformate line 24 where it is available for further use in the fuel cell stack 26.

Referring now to FIG. 3 there is illustrated a diagrammatic representation of an afterburner in accordance with the first example embodiment. The afterburner 36 comprises an oxidation zone 60 which receives a supply of fuel from a fuel feeder 62. The fuel feeder 62 is connected to the third fuel line 38 so that the fuel feeder 62 receives a supply of fuel of the grade as tanked in the second fuel tank 20. In the present embodiment the fuel feeder 62 is an injector and preferably a Venturi nozzle, but it is just as possible that the fuel is supplied by means of an evaporation type fuel feeder comprising a porous evaporator to the oxidation zone 60. Provided furthermore is an oxidant feeder 64 connected to the second oxidant line 40 by means of which oxidant of the oxidation zone 60 can receive a supply of oxidant. Within the oxidation zone 60 a reaction of fuel and oxidant in an exothermic oxidation reaction occurs, i.e. as near total combustion as possible, the resulting combustion exhaust gas then entering a downstream mixing zone 66, i.e. to the right in FIG. 3. The individual zones of the afterburner 36 are indicated separate from each other in FIG. 3 by broken lines. The zones may be separated from each other by structural features or interface flowingly. In the mixing zone 66 the resulting exhaust gases are admixed with anode exhaust gas by means of a mixer 34. The gas mixture admixed with the anode exhaust gas enters a combustion zone 68 which in the example embodiment as shown is filled with a porous body in which the gas mixture is combustioned near totally, i.e. the gas mixture becomes incandescent at the porous body in the combustion zone 68.

In one variant of the first example embodiment fuel is tanked of the same grade in the first fuel tank 16 and second fuel tank 20, but which differs as to its state of aggregation (i.e. gaseous, liquid). In this arrangement, for example, a certain fuel may be tanked in one tank liquid and fuel of the same grade may be tanked gaseous in another tank, achieved by a higher pressure existing both in the one tank and its corresponding fuel line than in the other fuel tank, maintaining the fuel in a gaseous condition.

It is to be noted that reference numerals used in the first example embodiment as follows identify like elements having the same functionality as in the first example embodiment, whose description is omitted to avoid tedious repetition.

Referring now to FIG. 4 there is illustrated a diagrammatic representation of a fuel cell system in accordance with a second example embodiment. The fuel cell system 10 of the second example embodiment differs from the fuel cell system as shown in FIG. 1 by instead of the first and second fuel tanks 16 and 20 only a single fuel tank 70 is installed in the motor vehicle. This fuel tank 70 supplies the first, second and third fuel line 14, 18, 38 with fuel of the same grade. In the second example embodiment the primary fuel feeder 50 of the reformer 12 and the fuel feeder 62 of the afterburner 36 are configured or operated so that the fuel supplied by the primary fuel feeder 50 of the reformer 12 features on entering the corresponding zone of the reformer 12 a temperature different to that of the fuel supplied by the fuel feeder 62 of the afterburner 36. For this purpose the primary fuel feeder 50 and fuel feeder 62 is provided with a heater/cooler (not shown). As an alternative this different feed temperature of the fuel may also be achieved by means of a heater/cooler in the first and/or third fuel line 14, 38. This difference in temperature may also result in the fuel in the primary fuel feeder 50 of the reformer 12 being fed in a different state of aggregation than in the fuel feeder 62 of the afterburner 36.

It is to be explicitly noted that although the individual example embodiments and their variants are described separate by way of the corresponding FIGs., all and any combinations of the various example embodiments and their variants is within the scope of the invention. For example, it is just as possible to combine the first and second example embodiments in which differing grades of fuel are supplied to a reformer and an afterburner at differing temperatures.

Although not explicitly shown in the FIGs. as described, corresponding delivery means such as for example pumps or blowers and/or control valves may be provided in the fuel lines 14, 18 and 38, in the oxidant lines 22 and 40 as well as in the cathode feed air line 28.

It is understood that the features of the invention as disclosed in the above description, in the drawings and as claimed may be essential to achieving the invention both by themselves or in any combination.

### LIST OF REFERENCE NUMERALS

10 fuel cell system
12 reformer
14 first fuel line
16 first fuel tank
18 second fuel line
20 second fuel tank
22 first oxidant line
24 reformate line
26 fuel cell stack
28 cathode feed air line
30 electric terminals
32 anode exhaust gas line
34 mixer
36 afterburner
38 third fuel line
40 second oxidant line
42 mixer
44 cathode exhaust air line
46 heat exchanger
48 oxidation zone
50 primary fuel feeder
52 oxidant feeder
54 mixing zone
56 secondary fuel feeder
58 reforming zone
60 oxidation zone
62 fuel feeder
64 oxidant feeder
66 mixing zone
68 combustion zone
70 fuel tank

1. A fuel cell system (40) comprising:
a reformer with first oxidation zone receiving a supply of tanked fuel by means of a fuel feeder for reaction with oxidant; and
an afterburner with second oxidation zone receiving a supply of tanked fuel by means of a fuel feeder for reaction with the oxidant,
wherein the fuel feeder of the reformer and the fuel feeder of the afterburner are designed to feed fuel such that the fuel supplied by the fuel feeder of the reformer differs from the fuel supplied by the fuel feeder of the afterburner as regards grade and/or state of aggregation and/or feed pressure and/or feed temperature.

2. The fuel cell system of claim 1, wherein the fuel feeder of the reformer is designed to be connected to a first fuel tank and the fuel feeder of the afterburner is designed to be connected to a separate second fuel tank.

3. A motor vehicle comprising a fuel cell system of claim 1.

4. The motor vehicle of claim 3, further comprising two fuel tanks are provided, one of which is connected to the fuel feeder of the reformer and the second fuel tank is connected to the fuel feeder of the afterburner.

5. A method of operating a fuel cell system comprising the steps:
feeding fuel from a fuel tank to an first oxidation zone of a reformer in which the fuel is reacted with the oxidant; and
feeding fuel from a fuel tank to an second oxidation zone of an afterburner in which the fuel is reacted with the oxidant,
wherein the feeding of fuel to the first oxidation zone of the reformer differs from the feeding of fuel to the second oxidation zone of the afterburner as regards grade and/or state of aggregation and/or feed pressure and/or feed temperature.

6. The method of claim 5, wherein the feeding of fuel to the first oxidation zone of the reformer is from a first fuel tank and the feeding of fuel to the second oxidation zone of the afterburner is from a separate second fuel tank.
